(19) United States
(12) Patent Application Publication
(10) Pub. No.: US 2006/0137252 A1
(43) Pub. Date: Jun. 29, 2006

(54) Opening and closing system for a motor vehicle sliding door

(76) Inventors: Olaf Kriese, Lautertal (DE); Andreas Heinrich, Wuppertal (DE); Manfred Stenzel, Bamberg (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/314,939

(22) Filed: Dec. 21, 2005

(30) Foreign Application Priority Data
Dec. 29, 2004 (DE) 10 2004 063 737.7

(51) Int. Cl. E05F 11/00

(52) U.S. Cl. 49/360

(57) ABSTRACT

Opening and closing system for motor vehicle sliding door, which can be displaced along guide rails between an open position and a closed position, with a brake device for braking the sliding door. The brake device is designed in such that it is activated automatically during displacement of the sliding door when a collision state is indicated or signaled or exists during opening and/or when a jamming state is indicated or signaled or exists during closing (pre-crash situation). The opening and closing system can thus react without any time delay to a jamming or collision state and can rapidly brake the displacement of the relatively heavy sliding door. At the same time or with a time offset, a drive motor for the motorized movement of the sliding door can be braked and/or reversed. The opening and closing system can be used both for manually operated and automatic sliding doors.

### FIELD OF THE INVENTION

The present invention relates to an opening and closing system for motor vehicles, in particular to an automatic opening and closing system with a function for protection against jamming.

### BACKGROUND OF THE INVENTION

Sliding doors are increasingly being used in motor vehicles, in particular in small transporters and minivans. Use is also increasingly being made of sliding doors which open and close automatically. Sliding doors have relatively high masses, so that, in order to achieve short braking times, brake devices may be provided for braking the sliding door. Such brake devices may at the same time also be used as door securing means, for example for securing the sliding door in an open position on inclined terrain.

DE 31 34 093 A1 (corresponding to GB 2 082 660 A) discloses a sliding door which is fixed on the guide rail by means of a member which can be moved in the guide rail in the longitudinal direction, wherein there is provided a brake for braking the movement of the member in the guide rail, an unlocking device for releasing the brake, and also a device for automatically releasing the brake immediately prior to the closing of the sliding door. In this case, the door handle can at the same time be designed as an unlocking lever for releasing the brake. A brake shoe is permanently prestressed against a supporting roller, which engages in the guide rail. In order to open the sliding door, the door handle must be actuated jointly with the unlocking handle, so that the brake shoe no longer bears against the supporting roller. Closure of the sliding door also requires actuation of the unlocking lever. Reliable anti-jamming protection can barely be achieved, since it is not guaranteed that the unlocking lever will be released quickly enough in the event of jamming.

DE 198 03 709 A1 (corresponding to U.S. Pat. No. 6,087,794) discloses an automatic opening and closing system for a vehicle sliding door, in which a holding force for holding the sliding door in a predefined position is to be kept constant in all operating states of the vehicle, that is to say even on inclined ground and in the case of a voltage drop of the on-board power supply. For this purpose, a specially designed control circuit is provided which compulsorily actuates a clutch device in the event of a drop in the power supply voltage fed to the control device. No jamming protection function is disclosed.

DE 196 81 592 B4 discloses a device for automatically controlling the opening and closing of a motor vehicle sliding door. The device comprises door position detection means for detecting the position of the sliding door guided by the guide rail, door speed detection means for measuring the movement speed of the sliding door, and motor control means for controlling the power supplied to the motor based on the difference between the stored motor load and the motor load which is detected for moving the sliding door to the current position. It also discloses a jamming protection function in which an assessment is made, based on a load resistance component, as to whether a jamming state exists or not. If a jamming state is ascertained, the drive is braked and/or reversed.

DE 196 81 592 B4 (corresponding to U.S. Pat. No. 6,164,015) discloses a device for automatically controlling the opening and closing of a sliding door for motor vehicles, in which the opening and closing is triggered by actuating a switch or a remote control, in order to control a drive motor. If a jamming state is detected on account of an abnormal current through the drive motor while the opening and closing switch is actuated, the automatic closing mode is stopped, the drive motor is reversed and an opening process is triggered. However, this requires active intervention of control electronics, that is to say does not take place automatically. Automatic activation of a brake device is not disclosed.

### SUMMARY OF THE INVENTION

The object of the present invention is to provide an opening and closing system for motor vehicle sliding doors, by means of which sliding doors can be braked even more effectively and rapidly. According to a further aspect of the present invention, a collision and/or jamming state is also to be more effectively prevented.

The present invention thus relates to an opening and closing system for a motor vehicle sliding door, which can be displaced along guide rails between an open position and a closed position, with a brake device for braking the sliding door. According to the invention, the opening and closing system is characterized in that the brake device is designed in such a way that it is activated automatically during displacement of the door when a collision state is indicated or signaled or exists during opening of the sliding door and/or when a jamming state is indicated or signaled or exists during closing (pre-crash situation).

The opening and closing system can thus advantageously react quickly to a jamming state or collision state or in general to a pre-crash situation. Since the brake device is activated automatically, the relatively heavy sliding door can be braked quickly and without any great time delay. The risk of jamming due to mechanical obstructions in the displacement path of the sliding door and the risk of collisions of the sliding door with mechanical obstructions can thus advantageously be reduced.

In principle, the opening and closing system according to the invention can be used both in the case of an exclusively manually operated sliding door and in the case of a sliding door that can optionally be operated manually or automatically, that is to say in the case of a sliding door which is assigned a dedicated drive mechanism, for example a cable system, for displacing the sliding door.

The brake device may be actuated by purely mechanical adjustment elements or, as an alternative or in addition, at least one electrically driven adjustment element may also be provided for actuating the brake device.

According to a further embodiment, the brake device is coupled to a force transmission element of a drive mechanism for transmitting the movement force to the sliding door, in such a way that the brake device is activated automatically when the movement force acting on at least one member of the force transmission chain is interrupted or eased. The intensity of the movement force for displacing the sliding door can thus signal the jamming or collision state or the pre-crash situation. To this end, it may be sufficient to couple the drive mechanism to the brake device in a suitable manner so that an interruption or easing of the movement force automatically activates the brake device. Complicated further detection means for ascertaining a jamming state and/or mechanical obstructions in the displacement path of the sliding door are thus not absolutely necessary. Furthermore, according to the invention, such detection means and/or control units arranged downstream thereof for processing the signals of the detection means and for controlling the drive motor and/or actuating the brake device do not cause further time delays, and this results in an advantageously rapid reaction time of the opening and closing system according to the invention.

The brake device may be directly or indirectly coupled to a drive train for driving the sliding door. When a cable drive is used, according to the invention any slackening of the cable can be used to automatically activate the brake device.

According to a further embodiment, the brake device comprises at least one brake element which is prestressed into a braking or blocking position, wherein the brake device is coupled to the force transmission element in such a way that the brake element is moved from the braking or blocking position into a released or rubbing position, counter to the prestress force, when the drive mechanism transmits the movement force and there is no interruption to or easing of the movement force acting on the force transmission chain. It can thus advantageously be ensured in a simple manner that the brake device is immediately and automatically activated as soon as the movement or driving force is interrupted or eased, for example due to a mechanical obstruction in the displacement path of the sliding door.

According to a further embodiment, the force transmission element comprises a door opening cable or a door closing cable of a cable mechanism for opening and closing the sliding door, and the brake element is automatically moved into the braking or blocking position when a pulling force on the door opening or door closing cable is interrupted or eased and falls below a predefinable value. The brake device is thus directly coupled to the cable which transmits the movement force to the sliding door, so that the brake device can be activated even more rapidly, for example when a jamming state or collision state or a pre-crash situation is signaled or ascertained. In this case, the aforementioned value can be predefined by the mechanical configuration of the brake device, for example a cable system for actuating the latter, or by a prestressing means, for example a spring.

According to a further embodiment, in the opening and closing system, a front end of the door opening or door closing cable is coupled to a pivoting lever, the lever axle of which is mounted in a fixed position with respect to a roller of the sliding door, wherein the pivoting lever has a brake element which cooperates with a roller, a guide rail assigned thereto or the like in a friction-fitting or form-fitting manner, in order to brake the displacement of the sliding door or to fix or block a stationary sliding door.

According to a further embodiment, the opening and closing system furthermore comprises a control device which is coupled to a jamming-state detection means and/or a displacement detection means, for electronically activating the brake device in reaction to the jamming state or collision state or the pre-crash situation being signaled by the respective detection means. In this embodiment, use is thus made of an active brake device, that is to say a brake device actuated by active adjustment elements, which can be provided in addition or as an alternative to a passive, mechanically actuated brake device.

The jamming-state detection means detects any obstructions in the displacement path of the sliding door which are jammed by the sliding door or which are under risk being jammed or colliding immediately following detection. The jamming-state detection means can sense or detect the obstructions electronically, optoelectronically or mechanically. By way of example, information about a jamming state or collision state can be ascertained from the driving force, the rotational speed or comparable parameters of a drive motor and/or of the drive system. The signals from the jamming-state detection means can also be evaluated electronically, for example by a control unit which is coupled to the drive motor. In particular, the jamming-state detection means may be designed as a contact bar or switch bar arranged along an edge of the sliding door.

The displacement detection means may detect a displacement travel of the sliding door and/or a rotational speed of a sliding door drive motor and/or the movement force, in order indirectly to determine a jamming state or collision state of the sliding door.

According to a further embodiment, the control device may be designed to stop or reverse a drive motor of the sliding door at the same time as or with a time offset to the signaling of the jamming state or collision state or the pre-crash situation. If the motor is driven in a reversed manner, that is to say in the opposite direction, the sliding door is thus moved back in the opposite displacement direction, so that a mechanical obstruction is no longer jammed.

According to a further embodiment, the brake device may have three operating modes, namely a released mode, in which the brake device is released and displacement is enabled; a blocking mode, in which the brake device is activated and displacement is blocked; and a braking mode, in which the brake device is activated in such a way that displacement of the sliding door is braked. In the braking mode, the braking action of the brake device can also be overridden, so that the sliding door can continue to be pushed open or closed against the braking force.

According to a further embodiment, the brake device is activated in a powerless state, in particular in the parked state of the vehicle (indicated for example by an automatic gearbox). By virtue of this simple measure, the break-in security of the vehicle is improved since the sliding door cannot be opened by unauthorized individuals in the powerless state. Activation of the brake device can in this case be effected by mechanical means, for example spring elements, or by electrical and/or magnetic means, for example permanent magnetic fields generated by a permanent magnet or the like.

According to a further embodiment, means for emergency unlocking of the brake device are provided in the interior of the vehicle, in particular on the inner side of the sliding door, in order to make it possible to exit the vehicle in the event of an emergency if the on-board power supply should fail. Such an emergency unlocking system may be implemented by mechanical means, for example by an unlocking mechanism which is coupled to the brake device in order to unlock the latter.

According to a further embodiment, the brake device is automatically and permanently deactivated in the event of a crash signal. Such a crash signal may be derived for example from the vehicle control electronics or be generated in the form of a control signal which releases an airbag. On account of the permanent deactivation of the brake device, it can be ensured that the vehicle occupants can leave the vehicle immediately after an accident, including by pushing open the sliding door.

According to a further embodiment, the brake device is activated or the braking process is prepared in the event of a pre-crash signal which indicates a jamming incident or a collision. In this way, the relatively heavy sliding door can be gently braked even prior to the actual jamming or collision state, so that the momentum forces when the jamming or collision state occurs are lower.

### BRIEF DESCRIPTION OF THE DRAWINGS

The invention will be described in more detail below by way of example and with reference to the appended drawings, from which there emerge further features, advantages and objects to be achieved. In the drawings:

FIG. 1 shows a schematic perspective view of a sliding door in an open and closed state;

FIG. 2 shows the design of a holder for supporting the sliding door as shown in FIG. 1;

FIGS. 3a and 3b show a brake device of a sliding door according to a first embodiment of the present invention, in a released mode and in a braking mode;

FIGS. 4a and 4b show a brake device of a sliding door according to a second embodiment of the present invention, in a released mode and in a braking mode;

FIG. 5 shows a schematic representation of an opening and closing system according to a first embodiment of the present invention;

FIGS. 6a and 6b show a schematic side view of a brake device of a sliding door according to a third embodiment of the present invention, in a braking mode and in a released mode;

FIG. 7 shows a schematic representation of an opening and closing system according to a second embodiment of the present invention;

FIG. 8a shows a schematic side view of a brake device of a sliding door according to a fourth embodiment of the present invention, in a braking mode;

FIG. 8b shows a schematic side view of a brake device of a sliding door according to a fifth embodiment of the present invention, in a braking mode;

FIGS. 9a to 9f show further embodiments of mechanical brake devices according to the present invention; and

FIG. 10 shows a schematic flow chart of the operation for implementing a jamming protection function of an opening and closing system according to the present invention.

Throughout the figures, identical reference numerals are used to denote identical elements or groups of elements or those having essentially the same function.

### DETAILED DESCRIPTION OF PREFERRED EXAMPLARY EMBODIMENTS

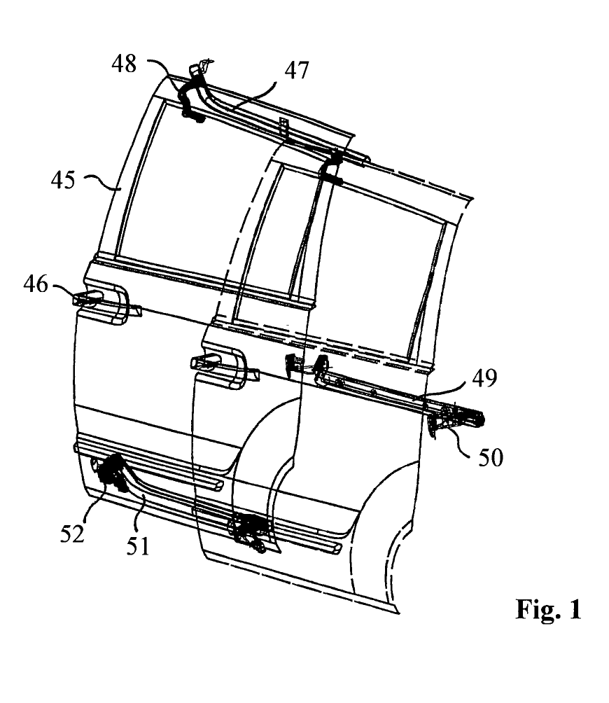

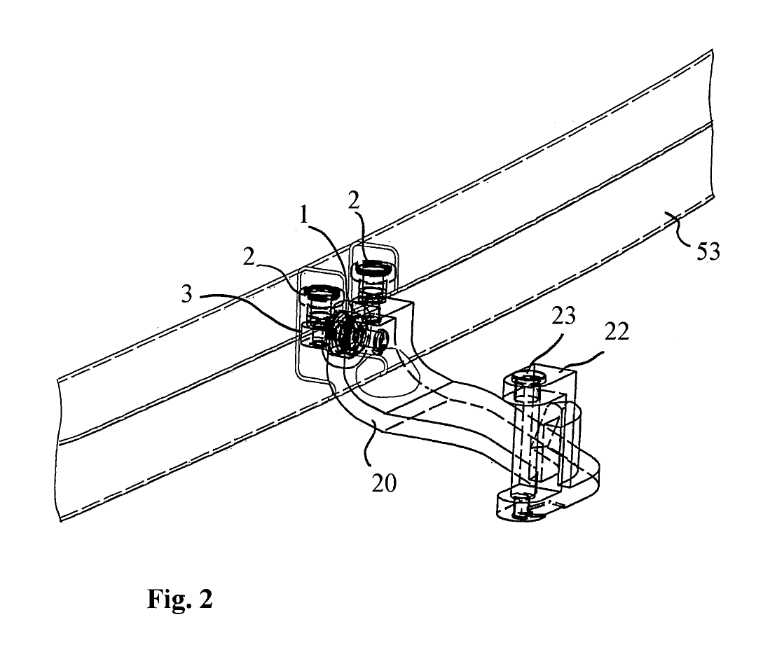

According to FIG. 1, the sliding door 45 is supported on the associated guide rails in the known manner by means of pivoting arms 48, 50, 52, namely on the upper guide rail 47, the central guide rail 49 and the lower guide rail 51. The guide rails 47, 49, 51 are curved in the known manner, with a respective straight section which defines a displacement plane of the sliding door 45 and with a respective front curved section which is curved in such a way that the sliding door 45 is moved in a direction transverse to the displacement plane at the start of opening of the door. FIG. 2 shows the engagement of a pivoting arm in an associated guide rail 53. As shown in FIG. 2, a rolling carriage 3 is formed at the front end of the pivoting arm 20, said rolling carriage comprising spaced-apart lateral guide rollers 2 and a central guide roller 1 which is oriented perpendicular to the lateral guide rollers 2. Formed at the rear end of the pivoting arm 20 is a holder 22 with a hole 23 for receiving a bolt for fixing the sliding door to the pivoting arm 20. As shown in FIG. 1, the upper guide rail 47 and the lower guide rail 51 are formed at the upper and lower edge of the door opening, whereas the central guide rail 49 is provided on the outer panel of the vehicle body.

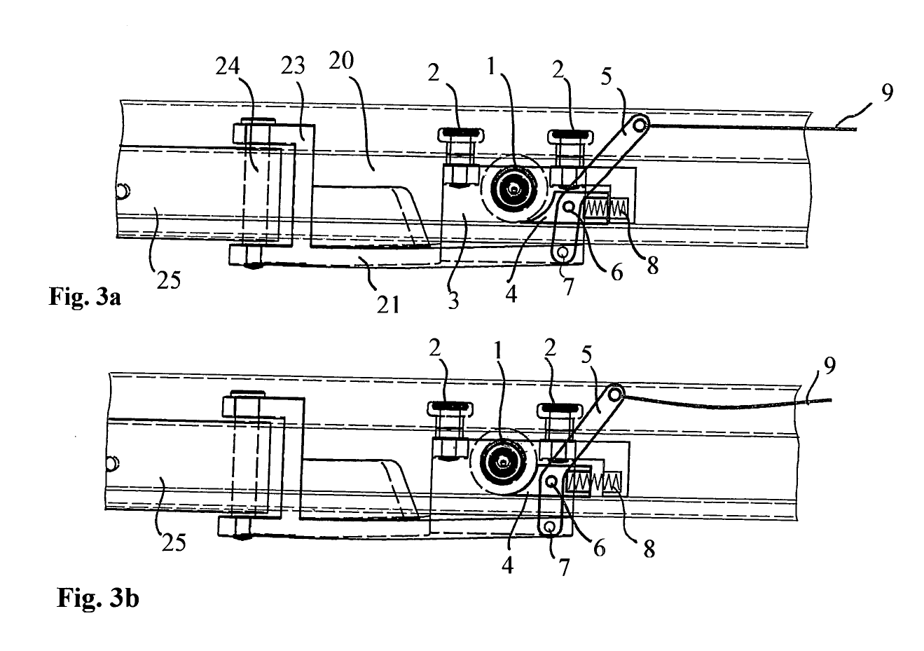

FIG. 3a shows a brake device according to a first embodiment of the present invention, in a released mode. As shown in FIG. 3a, the brake device comprises a pivoting lever 5 which is mounted at a free end of the pivoting arm 20, next to the rolling carriage 3 and the central guide roller 1. The pivoting lever 5 comprises a first straight section, at the front end of which the pivoting lever 5 is mounted such that it can pivot about the pivot axle 7, and on which the wedge-shaped brake shoe 4 is mounted, and also an angled region, at the front end of which a cable 9 is fitted. A pressure spring 8 prestresses the pivoting lever 5 together with the brake shoe 4 against the guide roller 1. In the released mode shown in FIG. 3a, a pulling force is exerted on the cable 9 (directed toward the right in FIG. 3a), which force pivots the pivoting lever 5 in the clockwise direction about the pivot axle 7 and in the process releases the brake shoe 4 from the guide roller 1 counter to the prestress force exerted by the pressure spring 8. As shown in FIG. 3a, the front end of the brake shoe 4 still rubs against the guide roller 1 in the released mode, so that a slight friction force acts as the sliding door is moved by pulling on the cable 9. The guidance of the pivoting lever 5 may also be designed in such a way that, during displacement of the sliding door, when a pulling force acts on the cable 9, the brake shoe 4 is fully released from the guide roller 1 and no longer rubs against the guide roller 1. As mentioned above, the cable 9 may be directly coupled to a drive mechanism (not shown) for displacing the sliding door, so that the pulling force for displacing the sliding door is applied by the cable 9. According to another embodiment, the cable 9 may also be indirectly coupled to the drive mechanism and is not, or not exclusively, responsible for transmitting the pulling force to the sliding door.

As shown in FIG. 3a, the cable 9 coupled to the drive mechanism is pulled taut when a pulling force acts thereon. The brake device is then in the released mode as shown in FIG. 3a, in which the brake shoe 4 does not bear against the guide roller 1 or bears against the latter only with its tip.

In this embodiment, the tension of the cable 9 can indicate a jamming state or collision state. Within the context of the present application, jamming state is to be understood to mean in particular the jamming of any object between the front end of the sliding door and the B-pillar of the vehicle. Within the context of the present application, collision state is to be understood to mean in particular the collision of the front end of the sliding door with any object within the door opening or of the rear end of the sliding door with any object outside the door opening of the vehicle. To this end, the case is considered where the sliding door is displaced to the right in FIG. 3a by pulling on the cable 9 and a resistance force acts counter to the pulling force, for example on account of a mechanical obstruction in the displacement path of the sliding door. If the difference between the pulling force and the resistance force is less than the prestress force exerted by the pressure spring 8, the pivoting lever 5 is automatically pivoted in the counterclockwise direction, as shown in FIG. 3b, until finally the brake shoe 4 bears fully against the associated guide roller 1 and brakes or blocks the latter. In the braked position shown in FIG. 3b, the cable 9 is consequently no longer pulled taut, and the movement of the sliding door is braked or a stationary sliding door is fixed or blocked.

As soon as a sufficiently great pulling force is applied to the cable 9, the latter again becomes taut. In particular, when the pulling force exceeds the prestress force of the pressure spring 8, the pivoting lever 5 is again pivoted in the clockwise direction so as to assume the released position shown in FIG. 3a.

Thus, in this embodiment, the brake device is activated automatically when the cable 9 signals a jamming state or collision state of the sliding door. In this case, the pivoting lever 5 is moved passively, that is to say without the use of active electronic adjustment elements.

As can readily be seen from FIGS. 3a and 3b, the brake device is designed to be self-locking and self-reinforcing, that is to say the brake shoe 4 always automatically migrates back into the gap between the guide roller 1 and the associated guide rail when the braking position is to be assumed. The further the brake shoe 4 penetrates into this gap, the greater the braking or blocking force.

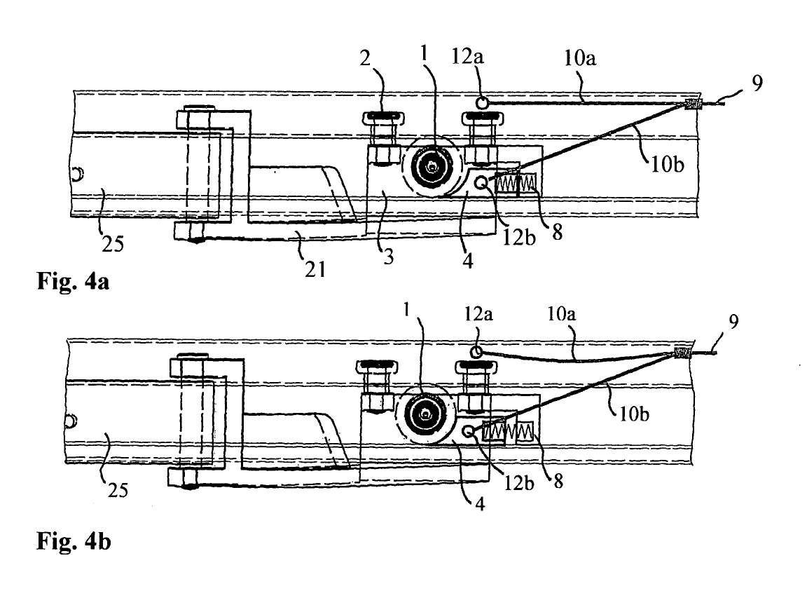

FIG. 4a shows a brake device according to a second embodiment of the present invention, in a released mode. As shown in FIG. 4a, the cable 9 branches at its front end into a first cable 10a, which is coupled to the rolling carriage 3 at the fixing point 12a, and into a cable 10b which is coupled to the brake shoe 4. The two cables 10a, 10b form the sides of a right-angled triangle. In the released mode shown in FIG. 4a, when the cable 9 is held taut counter to the prestress force of the pressure spring 8, the brake shoe 4 is released from the guide roller 1 or only the front edge of said brake shoe bears against the guide roller 1.

In the braking mode shown in FIG. 4b, the cable 10a is no longer held taut, while the prestress force of the pressure spring 8 ensures that the brake shoe 4 bears fully against the guide roller 1 in order to brake the displacement of the sliding door or to fix or block the stationary position of a sliding door, and also ensures that the cable lob continues to remain taut. In this embodiment, the jamming state or collision state of the sliding door is indicated by the stretching force of the cable 9. If, therefore, a pulling force is exerted on the cable 9 in order to displace the sliding door to the right in FIGS. 4a and 4b, and if a resistance force acts counter to the pulling force, for example on account of a mechanical obstruction in the displacement path of the sliding door, then the braking mode shown in FIG. 4b is assumed as soon as the difference between the pulling force and the opposing resistance force is less than the prestress force of the pressure spring 8. As soon as the last-mentioned condition is satisfied, the braking mode shown in FIG. 4b is automatically assumed, and this is brought about by the prestress force of the pressure spring 8.

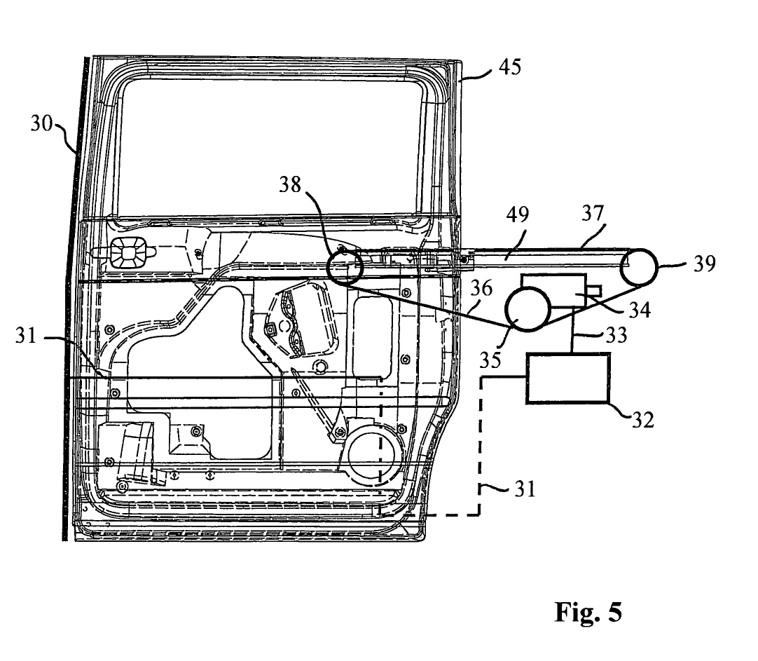

As will be readily obvious to the person skilled in the art, the brake device according to the first and second embodiment, as described above, is suitable both for manually operated sliding doors and for automatic, motor-driven sliding doors. One example of an automatic opening and closing system will be described below with reference to FIG. 5. As shown in FIG. 5, the sliding door 45 comprises a drive mechanism which comprises an electric drive motor 34, a cable drive wheel 35 and an arrangement of cable deflection rollers 38, 39 for deflecting the cable system. The cable deflection roller 38 is in this case mounted on the sliding door 45, and the cable deflection roller 39 is mounted on the vehicle body. In the text which follows, the case will be considered in which the sliding door in an open position is pulled forward, that is to say to the left in FIG. 5, in order to close the door opening of the vehicle. The cable section 36 then forms a door closing cable and the cable section 37 forms a door opening cable, which respectively act on the sliding door 45 in order to open and close the latter. As shown in FIG. 5, the drive motor 34 is connected to the control unit 32 via a control line 33. The control unit 32 comprises operating elements (not shown), for example knobs or buttons, for automatically opening and closing the sliding door 45 by actuating the drive motor 34. As shown in FIG. 5, a switch bar or contact bar 30 is provided on the front end of the sliding door 45, said bar comprising a plurality of switching contacts or the like which are actuated if the contact bar 30 strikes an obstruction. This indicates a jamming state or collision state, which is transmitted to the control unit 32 via the control line 31. A switch bar or contact bar may also be provided in a corresponding manner on the rear end of the sliding door 45 for indicating a collision state.

It will furthermore be assumed that the sliding door 45 comprises a brake device according to the first or second embodiment, as described above. Thus, if a jamming state or collision state or a pre-crash situation arises, the brake device is activated automatically, as described above, in order to brake the sliding door. In this case, the jamming state or collision state is signaled by a slackening of the door closing cable 36 which drives the sliding door. In addition, the jamming state or collision state or the pre-crash situation is signaled by the switch bar or contact bar 30, in order to activate the control device 32. If a jamming state or collision state or a pre-crash situation is ascertained, the control device 32 switches off the drive motor 34. This switching-off of the drive motor 34 may be effected at the same time as or with a time offset to the signaling of the jamming state or collision state or the pre-crash situation by the cable 36, as described above. Following braking of the drive motor 34, according to another embodiment the drive motor 34 may then also be reversed, that is to say operated in the opposite direction, in order to move the sliding door 45 back in the opposite direction so as to ensure that the mechanical obstruction does not continue to be jammed or the collision with a mechanical obstruction is cleared.

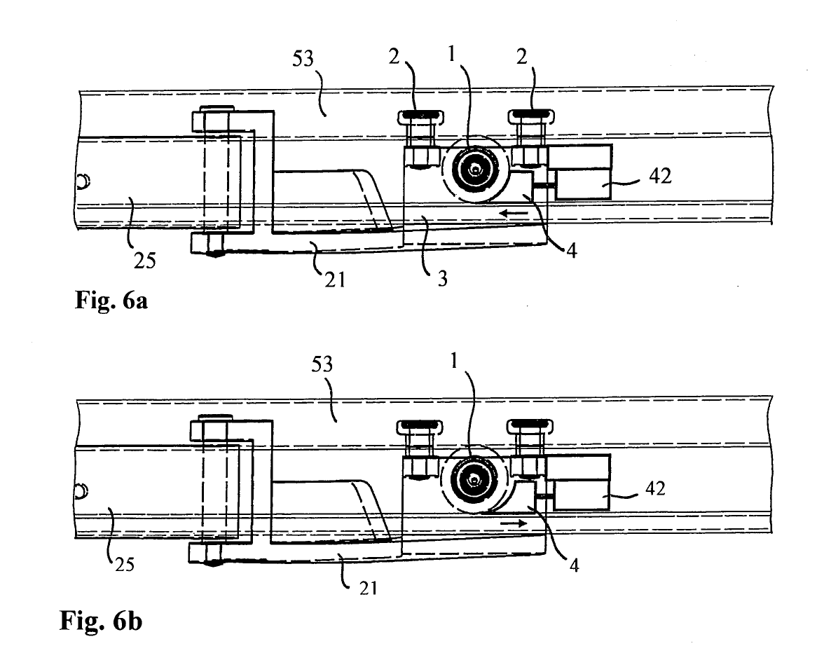

However, the present invention is not restricted to the use of passive brake devices which are actuated without the use of active adjustment elements. As an example, FIG. 6a shows a brake device according to a third embodiment of the present invention, in a braking mode. As shown in FIG. 6a, the brake device comprises an actuator 42 which presses the brake shoe 4 against the guide roller 1, as shown by the arrow, in order to brake the displacement of the sliding door or to fix or block a sliding door in a stationary position. The adjusting movement of the actuator 42 acting as an active adjustment element is triggered by an electronic signal, for example from the control device of the system as shown in FIG. 5. To this end, the adjusting movement of the actuator requires a dedicated power supply. FIG. 6b shows the brake device in a released mode, in which the actuator 42 has released the brake shoe 4 from the guide roller 1 as a result of displacement in the direction indicated by the arrow, and releases said brake shoe either completely or to the extent that only the front tip of the brake shoe 4 continues to bear against the guide roller 1 and rub against the latter, as shown in FIG. 6b.

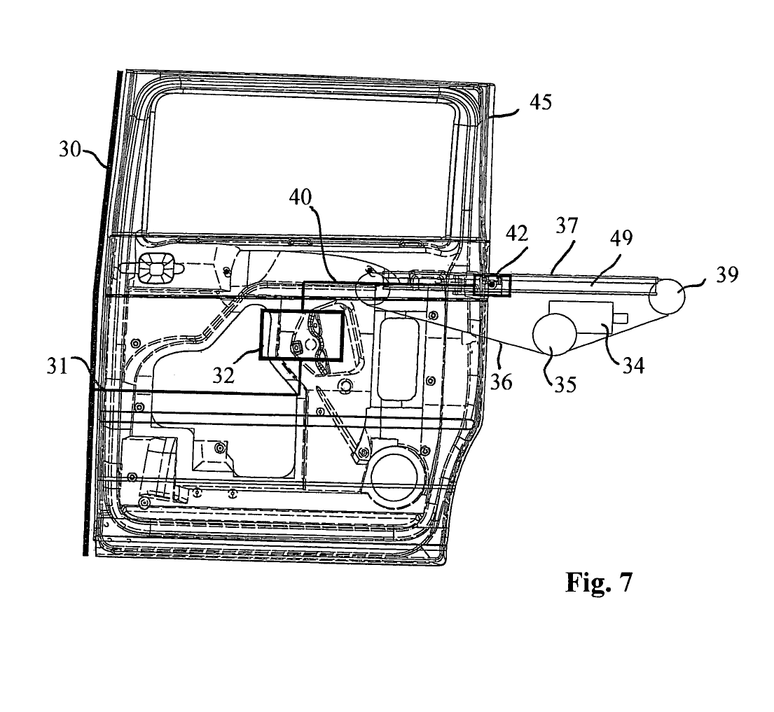

Such an active brake device, that is to say a brake device provided with active adjustment elements for moving brake or friction elements, may form part of an automatic opening and closing system as shown in FIG. 7. As shown in FIG. 7, the control unit 32 is coupled via the signal line 40 to the actuator 42, which activates the brake device in the manner described above. In the system shown in FIG. 7, the jamming state or collision state of the sliding door 45 is signaled by the switch bar or contact bar 30 or by further switch bars or contact bars (not shown), and is transmitted via the signal line 31 to the control unit 32, which then automatically activates the actuator 42. At the same time as or with a time offset to the activation of the brake device, the drive motor 34 can also be braked, as mentioned above, in order then to be reversed.

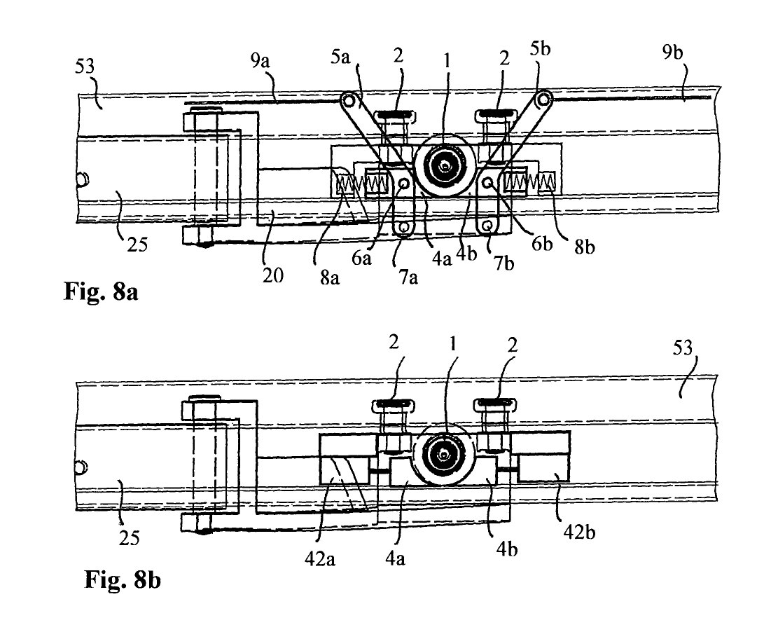

FIG. 8a shows a passive brake device according to a fourth embodiment of the present invention, in a braking mode. As shown in FIG. 8a, the brake device comprises two pivoting levers 5a, 5b which are arranged on opposite sides of the guide roller 1, but are otherwise designed and coupled in the manner described above with reference to FIGS. 3a and 3b. In this embodiment, the cable 9a serves to displace the sliding door to the left in FIG. 8a, and the cable 9b serves to displace the sliding door to the right in FIG. 8a. In the braking mode shown in FIG. 8a, both cables 9a, 9b are taut, so that the associated brake shoes 4a, 4b bear fully against the guide roller 1 and brake or block the latter. If, for example, the cable 9b is pulled to the right in FIG. 8a, the pivoting lever 5b is pivoted in the clockwise direction in the manner described above, in order to release the brake shoe 4b from the guide roller 1. At the same time, the cable 9a is automatically slackened. Since the brake shoe 4a is self-locking or self-reinforcing only in respect of a displacement to the left in FIG. 8a, the sliding door is thus displaced to the right counter to the friction force exerted by the brake shoe 4a. Of course, the brake device can also be designed in such a way that, when the cable 9a or 9b is pulled, the respective other cable, that is to say the cable 9b or 9a, also automatically becomes taut, in order to release the associated brake shoe from the guide roller 1.

FIG. 8b shows a corresponding active brake device according to a fifth embodiment of the present invention, in a braking mode in which the brake shoe 4b bears fully against the guide roller 1 and only the front tip of the wedge-shaped brake shoe 4a bears against the guide roller 1. The position of the brake shoe 4a, 4b is controlled by the associated actuators 42a, 42b, as mentioned above.

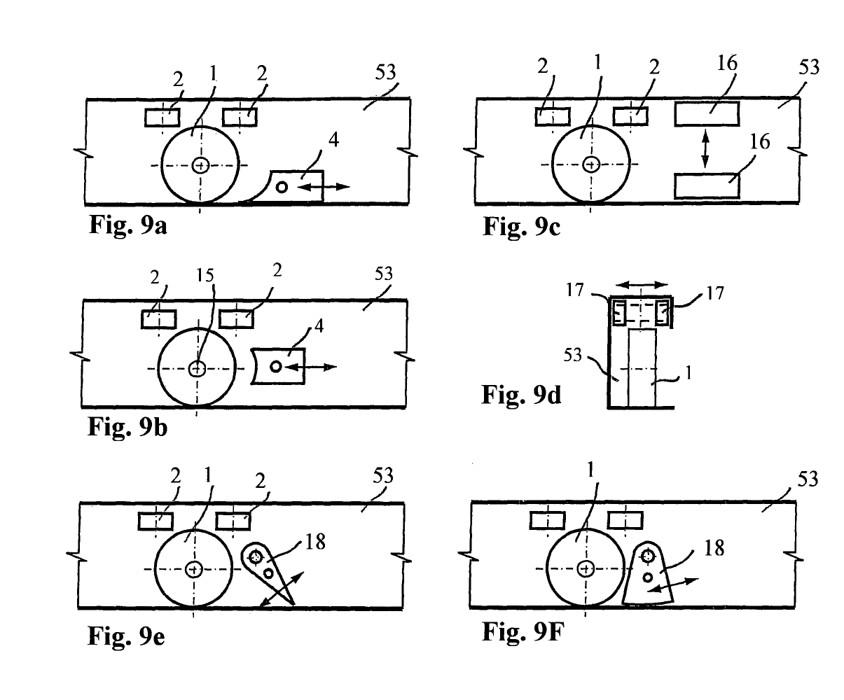

FIGS. 9a-9f outline further embodiments of passive brake devices. According to FIG. 9a, the brake shoe 4 is wedge-shaped and is arranged in such a way that, in order to brake the guide roller 1, firstly the front tip of the brake shoe 4 enters the gap between the guide roller 1 and the associated guide rail 53, in order then to penetrate further into the gap so as to block the roller 1. According to FIG. 9b, the brake shoe 4 is designed to be symmetrical and is moved radially toward the guide roller. In these embodiments, the braking function is effected between a guide roller and the associated guide rail. In further embodiments according to this principle, the guide rail may also have a brake actuator, so that the guide roller is actively displaced therein, or else the guide roller may have a brake actuator.

According to FIG. 9c, the brake device comprises two spaced-apart vertical friction elements 16 which, as shown by the double arrow, can be displaced outward in a symmetrical manner in order to come to bear against guide surfaces of the guide rail 53 and thus brake the movement of the rolling carriage. FIG. 9d shows the arrangement of FIG. 9c in cross section.

According to FIG. 9e, the rolling carriage comprises a pivotable friction element 18 which, as shown by the double arrow, can be pivoted toward the guide rail 53 in order to brake the movement of the rolling carriage. According to FIG. 9f, the pivotable friction element 18 is designed to be self-locking, so that the braking action which is exerted is greater the further the friction element 18 is moved in the clockwise direction toward the guide roller 1 and the side wall of the guide rail 53. The friction element 18 finally bears both against the guide roller 1 and against a side wall of the guide rail 53.

The braking function can thus also be effected between the rolling carriage and the rail, either by means of a form-fitting engagement, in which for example an element latches into a grating of the guide rail, or by means of a force-fitting engagement, in which an element latches for example between guide edges, for example by virtue of a change in width. The braking function can moreover be effected between the rolling carriage and a roller of the rolling carriage, for example by a disk brake, by an additional brake roller, an inclined plane, a wedge or a brake shoe, by a sprocket or by a wrap-around spring. The braking function can furthermore be realized directly on the drive unit, for example by disconnecting the clutch (for example by changing the current flow direction), so that the clutch in the braking mode then presses against a brake disk.

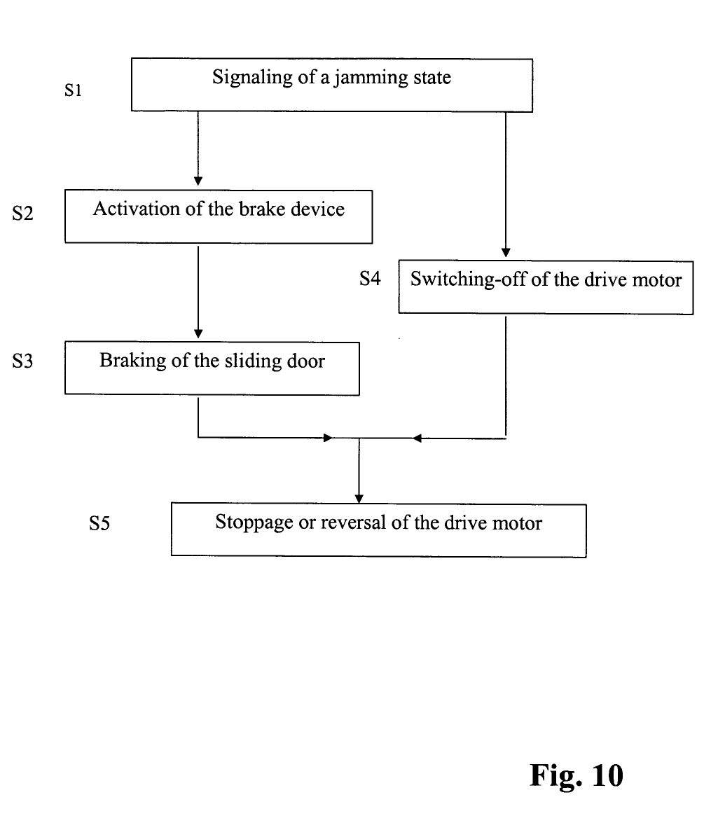

FIG. 10 shows by way of example the operating steps of an automatic opening and closing system according to the present invention, as mentioned above.

According to the present invention, end states of the sliding door, in particular the fully open or fully closed position of the sliding door, may be defined in a manner independent of the rest current. This is because, in the passive brake device as described above with reference to FIGS. 3a-4b, the braking mode exists when no pulling force acts on the cable.

As mentioned above, the at least one brake element of the brake device automatically blocks the sliding door when the pulling force no longer acts on the sliding door in order to displace the latter. This is the case in particular when the sliding door is in a forward end position and is locked by a door lock. According to another aspect of the present invention which can also be claimed independently, this blocking function of the brake device can also be used as an additional anti-break-in function on motor vehicles with sliding doors. This is because, even if, with the sliding door fully closed, the door lock of the sliding door is broken open and an attempt is made to force open the sliding door, the brake device continues to reliably block the sliding door until the drive mechanism is actuated, but this may require authentication of the vehicle proprietor.

According to another aspect of the present invention, the above-described blocking function can be used in the case of an open sliding door also to additionally hold the sliding door in the stationary position, for example when the vehicle is on inclined ground and additional downhill forces are acting on the sliding door to displace the latter toward a front or rear end position.

As will be readily obvious to the person skilled in the art, the abovementioned self-locking braking effect of a friction or braking wedge can be released again for example by an opposite movement of the sliding door or by a manually switched free-rolling mechanism through additional mechanical actuation. Alternatively, the fixing unit can be overcome by excessive stress on the inside or outside door handle, for example by connecting a Bowden cable.

Alternatively, the brake device according to the invention may have three modes, namely a self-reinforcing braking mode, which occurs only in the event of braking until the door is stationary, a holding mode, which is not self-reinforcing and can be overridden, and a free-running mode or released mode, in which the brake device is released and displacement is enabled. The self-reinforcing braking mode is assumed in particular immediately before reaching an end position of the sliding door (fully closed or fully open position of the sliding door), so that a soft-stop function and quiet closing of the sliding door can be achieved. This allows a simpler design of the sliding door system overall, since according to the invention lower momentum forces are exerted, particularly in the case of a jamming or collision state.

What is claimed as new and is desired to be secured by Letters Patent of the United States is:

1. An opening and closing system for a motor vehicle sliding door, which can be displaced along guide rails between an open position and a closed position, comprising a brake device for braking the sliding door, said brake device being configured such that it is activated automatically during displacement of the sliding door when a collision state is indicated or signaled or exists during opening of the sliding door and/or when a jamming state is indicated or signaled or exists during closing (pre-crash situation).

2. The opening and closing system as claimed in claim 1, wherein the brake device is coupled to a force transmission element of a drive mechanism for transmitting the movement force to the sliding door, in such a way that the brake device is activated automatically when the movement force acting on at least one member of the force transmission chain is interrupted or eased.

3. The opening and closing system as claimed in claim 2, wherein the brake device comprises at least one brake element which is prestressed into a braking or blocking position, wherein the brake device is coupled to the force transmission element in such a way that the brake element is moved from the braking or blocking position into a released or rubbing position, counter to the prestress force, when the drive mechanism transmits the movement force and there is no interruption to or easing of the movement force acting on the force transmission chain.

4. The opening and closing system as claimed in claim 3, wherein the force transmission element comprises a door opening cable or a door closing cable of a cable mechanism for opening and closing the sliding door, and wherein the brake element is automatically moved into the braking or blocking position when a pulling force on the door opening or door closing cable is interrupted or eased and falls below a predefinable value.

5. The opening and closing system as claimed in claim 4, wherein a front end of the door opening or door closing cable is coupled to a pivoting lever, the lever axle of which is mounted in a fixed position with respect to a roller of the sliding door, wherein the pivoting lever is coupled to a brake element which acts on the roller.

6. The opening and closing system as claimed in claim 4, wherein a front end of the door opening or door closing cable is coupled to the sliding door, in particular to a rolling carriage of the sliding door, wherein the brake element is coupled to the front end.

7. The opening and closing system as claimed in claim 1, further comprising a control device which is coupled to at least one of a jamming-state detection means and a displacement detection means, for electronically activating the brake device in reaction to one of the jamming state and collision state being signaled by the respective detection means.

8. The opening and closing system as claimed in claim 7, wherein the jamming-state detection means is one of a contact bar and switch bar arranged along an edge of the sliding door.

9. The opening and closing system as claimed in claim 7, wherein the displacement detection means detects at least one of a displacement travel of the sliding door and of a rotational speed of a sliding door drive motor and of the movement force, in order indirectly to determine a jamming state or collision state of the sliding door.

10. The opening and closing system as claimed in claim 7, wherein the control device is designed to stop or reverse a drive motor of the sliding door at the same time as or with a time offset to the signaling of the jamming state or collision state.

11. The opening and closing system as claimed in claim 7, wherein the control device is coupled to a brake actuator of the brake device, which moves at least one brake element of the brake device into a braking or blocking position.

12. The opening and closing system as claimed in claim 1, wherein the brake device has three operating modes, namely
a released mode, in which the brake device is released and displacement is enabled;
a blocking mode, in which the brake device is activated and displacement is blocked; and
a braking mode, in which the brake device is activated in such a way that displacement of the sliding door is braked shortly before reaching an end position.

13. The opening and closing system as claimed in claim 12, wherein the brake device is configured such that the blocking mode is assumed when the sliding door is located in an end position, in particular the open or closed position, or when the sliding door is stopped in a position at a desired degree of opening.

14. The opening and closing system as claimed in claim 1, wherein the brake device has at least one wedge-shaped brake shoe which, for braking purposes, can be inserted into an intermediate space between a roller supporting the sliding door and an inner wall of a guide rail assigned to the roller.

15. The opening and closing system as claimed in claim 1, wherein the brake device comprises two brake elements arranged on opposite sides of a roller supporting the sliding door, which brake elements are moved in opposite directions upon activation of the brake device in order to brake or block the sliding door.

16. The opening and closing system as claimed in claim 1, wherein the brake device is activated in a powerless state, in particular in a parked state.

17. The opening and closing system as claimed in claim 1, wherein means for emergency unlocking of the brake device are provided in the interior of the vehicle, in particular on the inner side of the sliding door, in order to make it possible to exit the vehicle in the event of an emergency if the on-board power supply should fail.

18. The opening and closing system as claimed in claim 1, wherein the brake device is automatically permanently deactivated in the event of a crash signal.

19. The opening and closing system as claimed in claim 1, wherein the brake device is activated or the braking process is prepared in the event of a pre-crash signal which indicates a jamming incident or a collision.

20. The opening and closing system as claimed in claim 1, wherein an electronic control device processes all the signals provided for door control, executes the algorithms for protection against jamming or collisions, and controls the drive and the brake device.
